(19) United States
(12) Patent Application Publication
(10) Pub. No.: US 2005/0097025 A1
(43) Pub. Date: May 5, 2005

(54) System and method for settling transactions on an eroding basis

(76) Inventors: Bruce M. Horton, Phillipsburg, NJ (US); Kurt C. Ehrilch, Middletown, NJ (US); Robert Allen Levin, Millburn, NJ (US); Charles V. Bebel, Matawan, NJ (US); Anthony Di Benedetto, Staten Island, NY (US); Jay Lester Gottlieb, New York, NY (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/699,314

(22) Filed: Oct. 31, 2003

(51) Int. Cl. G06F 17/60

(52) U.S. Cl. 705/37

(57) ABSTRACT

Systems and methods for trading and clearing eroding futures contracts on an exchange. Eroding futures contracts are futures contracts in which the contract size or open position size is determined as a balance remaining on a contract that is finally settled incrementally over time. The contract includes a delivery process that reflects reduction of contract size (e.g., by financial settlement) during the delivery period until no value remains for the contract.

### BACKGROUND OF THE INVENTION

1. Field of the Invention

The present invention relates, in general, to transaction settlement procedures, and, more particularly, to software, systems and methods for automatically and/or semi-automatically settling futures contracts on an eroding basis.

2. Relevant Background

A futures contract is an agreement between a buyer and seller that is finally settled at some time in the future. In the case of a “cash settled” futures contract, upon termination the contract is settled by a financial transaction. In a “physical delivery” futures contract the exchange involves delivery of a fixed amount of a commodity. In either case, the contracts are standardized so that the price of the contract has a strong relationship to the value, and the expected fluctuations in value, of an underlying commodity such as agricultural products, metals, energy products, and the like.

As the market price at the time of delivery may vary from the pre-negotiated price, the futures contract provides a mechanism for shifting risks associated with price volatility between the seller and buyer. Futures contracts may specify a final settlement to occur at any time in the future, although the value of the contract becomes increasingly speculative for final settlements farther in the future. Futures contracts are traded until a set point in time before the contract-specified final settlement date. The final settlement date is often referred to as the “delivery date” even in cases where the contract is cash-settled rather than physically delivered.

Futures contracts are traded exclusively on regulated exchanges. These exchanges create accounts for buyers and sellers and a marketplace where the futures contracts can be bought, sold, and exchanged. Like any market, a regulated exchange strives to bring as many buyers and sellers together as possible and to minimize transaction overhead so that the market is efficient. Further, the exchanges strive to provide a market that reliably captures and records transactions, and executes those transactions efficiently and precisely.

Futures markets arose around agricultural products and later extended to physical goods such as metals, petroleum and the like. These types of goods exhibit variations in supply and demand that cause price volatility. Futures contracts provide a mechanism for allocating the risk of price volatility between producers, distributors, marketers, and consumers of a product. Hence, futures exchanges became a natural extension for these types of goods to enable market participants to better manage risks created by price volatility.

Over time, futures exchanges have developed systems and methods to trade futures contracts for a variety of other types of products that exhibited volatile prices, including energy products such as electricity. A competitive electricity market has developed through structural and regulatory changes in the power industry that have evolved in recent years, resulting in price volatility and associated market risk. Electricity lends itself to futures trading because prices are volatile: there is a large, diverse universe of buyers and sellers, and the physical product is fungible.

Although futures trading is often associated with speculators, an important function of futures contract trading remains risk hedging by producers, distributors and consumers of the underlying commodity. Accordingly, a successful futures contract desirably has terms and conditions that correspond well to the needs of the market participants. For example, a futures contract that specified delivery at a difficult or impossible location would not be popular for market participants. Likewise, a futures contract that is sized much differently (e.g., larger or smaller) than desired by the market participants becomes unpopular and difficult to trade.

In an effort to offer futures contracts that more closely match industry desires, off-exchange markets have introduced hedging instruments that feature an “eroding” contract size for electricity futures. In conventional (i.e., non-eroding) contracts a single settlement event is specified which occurs during the final month of the futures contract. In this settlement the entire futures contract is settled either financially or through physical delivery. In contrast, an eroding contract size allows for multiple final settlement events for a given contract. After each final settlement, the remaining contract size is reduced by the amount settled. The remaining contract can be traded until the last final settlement, which adds a degree of control that is difficult to create when only a single settlement event is specified.

Over the counter hedging instruments have the advantage of flexibility in that contract size, delivery location, and the like can be non-standardized and so more readily customized to particular market needs. However, these transactions lack many of the benefits of an exchange-traded transaction. For example, off-exchange transactions are not financially cleared and so the parties assume a significant amount of counterparty credit risk. This added risk burdens the use of off-exchange products and transactions. Accordingly, a need exits for a flexible futures product for electricity markets that can be traded on a financially cleared exchange.

### SUMMARY OF THE INVENTION

Briefly stated, the present invention involves systems and methods for trading and clearing eroding futures contracts on an exchange. Eroding futures contracts are futures contracts in which the contract size or open position size is determined as a balance remaining on a contract that is finally settled incrementally over time. The contract includes a delivery process that reflects reduction of contract size (e.g., by financial settlement) during the delivery period until no value remains for the contract.

Alternatively an eroding futures contract may be defined as a composite or strip comprising a specific number of component contracts in which the contract balance reflects the quantity or number of unsettled component contracts. The contract includes a delivery process that reflects reduction of contract quantity (e.g., by cash settlement) during the delivery period until no open component exists for the contract.

In one aspect, the present invention involves a method for processing a futures contract by defining an eroding futures contract that has a defined size and a plurality of defined final settlement events, wherein the contract specifies a period of time over which the plurality of defined final settlement events are scheduled to occur. Trades are executed between buyers and sellers of what remains of the eroding futures contract. The present invention also involves an eroding futures contract including an agreement specifying a starting open position size, a term, and a plurality of independent contract increments. A plurality of final settlement events are defined to occur during the contract term, where each contract increment is associated with at least one final settlement event. Each contract increment is associated with only one final settlement. In a particular embodiment, each contract increment involves two steps: 1) an interim pending settlement and 2) final settlement.

### BRIEF DESCRIPTION OF THE DRAWINGS

FIG. 1 shows a trading environment in which the present invention is implemented;

FIG. 2 shows a calendar for determining peak days in a particular embodiment of a variable futures contract implementation in accordance with the present invention;

FIG. 3 illustrates a table for determining the number of peak days in a contract month;

FIG. 4 shows a specific example of a contract eroding during a contract month;

FIG. 5 illustrates in flow diagram form daily activities in a particular implementation of the present invention;

FIG. 6 shows an exemplary variable size contracts recap record in accordance with an embodiment of the present invention;

FIG. 7 is an exemplary daily trade and position register in accordance with an embodiment of the present invention; and

FIG. 8a and FIG. 8b illustrate an example of a daily erosion file used for communicating information about eroding futures contracts in accordance with the present invention.

### DETAILED DESCRIPTION OF THE PREFERRED EMBODIMENTS

The present invention is described in terms of electricity futures, however, it should be understood that other commodity markets have characteristics that will benefit from the teachings of the present invention. In particular, commodity markets with volatile demand, volatile production costs, and/or volatile distribution characteristics will benefit from the eroding futures contract products described herein. Accordingly, unless specified to the contrary, the present invention is applicable to a wide variety of markets and futures contracts whether now known or developed in the future.

The present invention is described in terms of a particular implementation that involves futures contracts with a variable contract unit, however, it is applicable to futures contracts with fixed contract unit sizes as well. Conventionally, futures contracts involve a fixed size of a commodity. Each contract involves a standard “contract unit” and one could buy or sell multiple contracts to achieve a particular goal. However, the electricity markets found fixed contract units less than ideal and so electricity futures contracts often involve a contract unit that varies in size from month-to-month in a manner that roughly aligns with electricity usage. These types of futures contracts are referred to herein as “variable quantity contracts” or “variable size contracts”. Variable quantity contracts where the contract size varies month-to-month according to a predetermined schedule. In a particular example, the number of peak usage days, as determined by the electricity industry, varies from month-to-month and variable size futures contracts are a more appealing way of modeling the financial risks of the industry itself.

Variable quantity contracts, described above, should be distinguished from eroding contracts. Eroding contracts may involve either variable contract units (e.g., variable size or quantity) or conventional fixed contract unit futures products. Eroding contracts in accordance with the present invention are characterized as having multiple final settlements that occur during the settlement period. As a result after each final settlement, only a portion of the contract remains.

The specific implementations herein involve monthly, weekly, and daily futures contracts for electricity. However, any time period that is convenient for a particular product may be used. For example, some markets may benefit from a bi-weekly or semi-annual contract depending on the factors that drive price volatility of the underlying commodity. In the electricity markets, price volatility is driven by such factors as demand fluctuation, generation capacity, fuel cost, seasonal price variation, and other production costs. With these types of fluctuations, weekly and monthly contracts have been found to be appropriate. The present invention is readily applicable to both cash-settled and physical delivery markets such as natural gas, oil, currencies, treasury bonds, or any commodity particularly where commercial conventions involve trading balance of month contracts.

Regulated exchanges such as the New York Mercantile Exchange (NYMEX), assignee of the present invention, implement both open outcry and electronic trading systems as well as clearing systems to conduct futures contract exchanges in an orderly manner. The trading and clearing systems work cooperatively to accept orders, matches and records orders; collects and maintains margins; allocates margins according to the positions of the clearing members; matches open short with open long positions for delivery; allocates delivery notices; and generates trading and delivery statistics. An exchange's clearinghouse also acts as a fiscal transfer agent, transferring money from the margin funds of traders who have incurred a loss in the futures market on any given day to the margin funds of traders who have generated a gain. The exchange's clearing members accept responsibility for all trades cleared through them, and share secondary responsibility for the liquidity of the exchange's clearing operation.

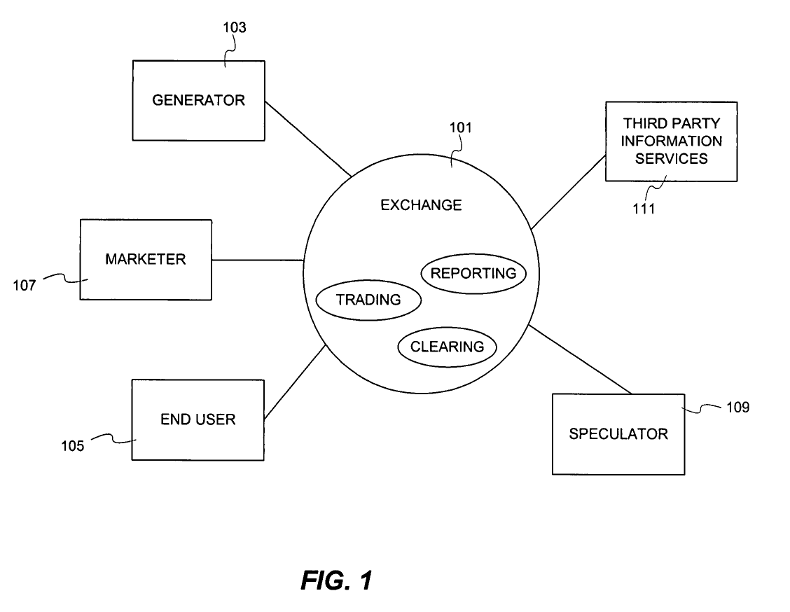

As shown in FIG. 1, the present invention involves an exchange system for futures contracts, including eroding futures contracts, involving an exchange 101 that supports cleared and financially settled futures trading between producers of a commodity such as electricity generators 103, end users of a commodity 105, and distributors or marketers 107. End users 105 do not necessarily refer to the ultimate consumers such as individual businesses and homeowners, but more frequently refer to entities such as power companies that purchase electricity from the power grid and deliver electricity to the ultimate consumer. However, manufacturers that consume large quantities of electricity may indeed wish to participate in the futures exchange. Essentially, end users 105 include anyone with sufficient risk exposure to price volatility that they desire to buy and/or sell futures contracts to mitigate that risk. Similarly, it is contemplated that some producers of electricity from alternative sources such as solar, wind, and similar alternative sources may wish to participate in futures trading in addition to more conventional producers such as power companies. Power companies are often both producers 103 and consumers 105, and may well be marketers/distributors 107 as well.

Market participants also include speculators 109. Speculators 109 do not participate in futures trading to hedge any particular risk in the underlying commodity, but instead attempt to profit from the volatility of the futures contracts. Speculators play an important role in that they add liquidity to the exchange. In essence, a speculator provides a ready buyer when another market participant wishes to sell a contract, and provides a ready seller when another market participant wishes to buy a futures contract.

Information services 111 are often a passive yet nevertheless important part of an exchange environment. The exchange system 101 produces a vast quantity of data about trades that have been completed, current prices, price trends, and the like. Information services 111 make that data available either in raw form (e.g., ticker data) or in processed form (e.g., reports, charts and the like). This information is used by the market participants to determine when to make trades, and is often used by a wide variety of businesses and government agencies as indicators for such things as interest rates, inflation precisions, consumer prices index, and the like. Settlement prices on futures contracts are often used as the price at which physical transactions are executed, and information services 111 provide a ready means for distributing the data necessary.

Exchange system 101 comprises a regulated futures trading exchange in the particular implementation. Exchange 101 implements systems that create and manage accounts for buyers and sellers, enable market participants to communicate transaction information, and execute transactions in a reliable fashion. Exchange 101 includes systems and software that support large trading volumes, provide clearing processes, and provides buyers and seller with sufficient information about completed transactions so that they can better value their own transactions.

Exchange 101 may include “open outcry” and/or automated or electronic trading systems. Open outcry trading takes place on a physical trading floor where brokers exchange bids and offers for futures contracts. Executed trades are then recorded by hand or entered into an electronic recording system. The completed trades are later sent to an external or internal clearinghouse to process the trades and issue appropriate reports to the futures exchange and its members. Futures markets are also maintained on electronic trading systems. These electronic trading systems allow entry of a bid or offer for a particular futures contract. The orders are time stamped by the trading system as they are entered. The system then matches a bid with an appropriate offer. Bids and offers are matched in the sequence in which they are received. Hence, a buyer does not select a particular seller. The trading system then generates appropriate information for the clearinghouse.

“Clearing” refers to the processes of registration and settlement of a trade that includes provisions for margin requirement and performance guarantee. The “settlement price” is the price established by the exchange settlement committee at the close of each trading session and is the official price to be used by the clearinghouse in determining net gains or losses as well as margin requirements. In the case of the eroding futures contracts in accordance with the present invention the settlement is somewhat complex in that the size of the expiring contract changes over time (e.g., on a daily basis) as a portion of the contract is settled out each day. Accordingly, the software and systems of the present invention support the clearing of variable quantity contracts.

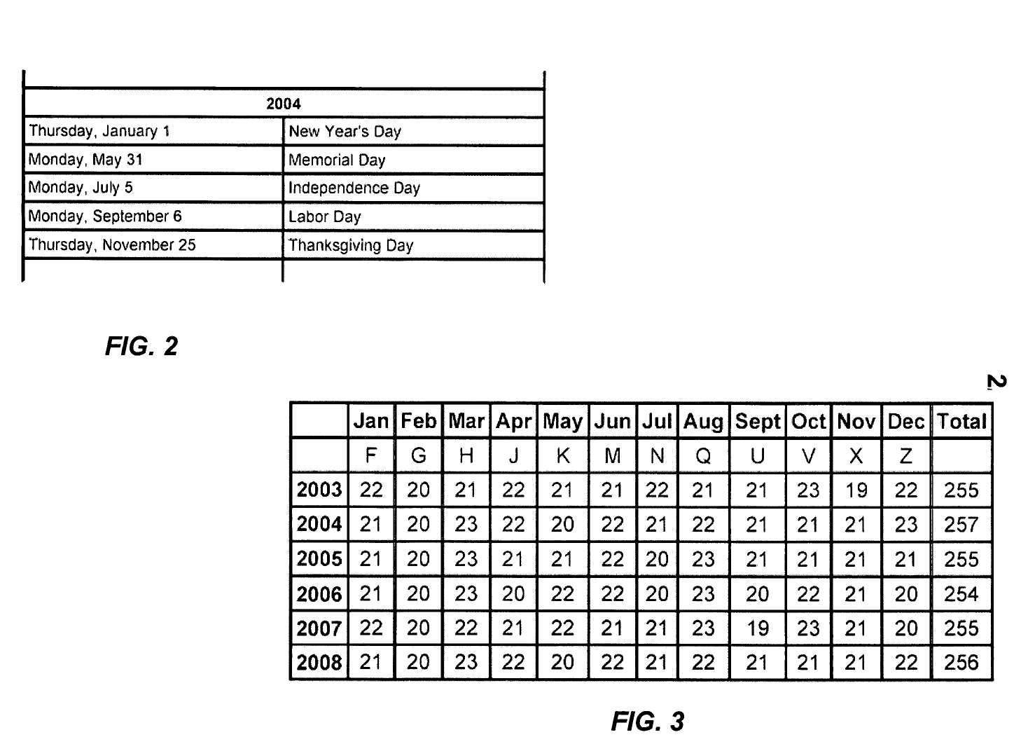

The quantity involved in a fixed quantity contract remains the same for each month. The quantity involved in any particular variable unit electricity futures contract may be determined by the number of peak hours in a day and the number of peak days in the contract month or week. Peak days in the eastern United States, for example, include all weekdays with the exception of six holidays as determined by the North American Electric Reliability Council (NERC). FIG. 2 illustrates the NERC holiday calendar for 2004 indicating the specific days that will be excluded from the peak days for a particular year.

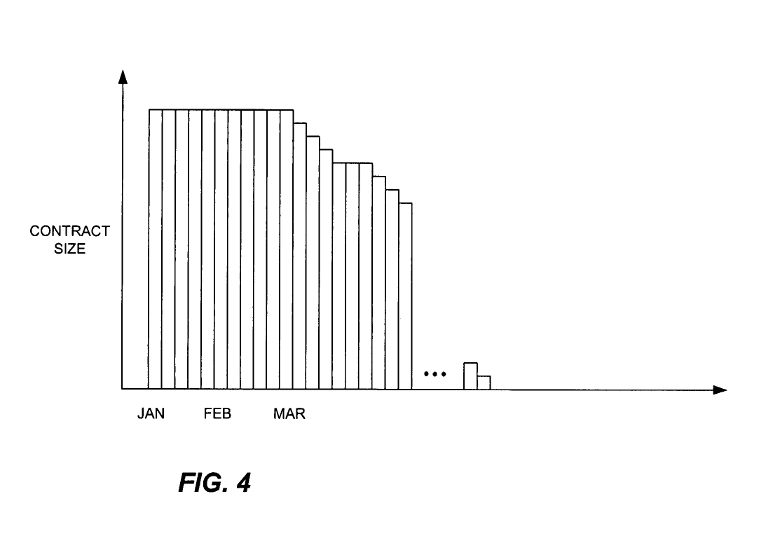

Using the holiday schedule, one can determine the number of peak days in each month far in advance as shown in FIG. 3. Significantly, the size of a November 2005 contract is different from the size of an August 2005 contract. By way of a particular example of a variable size electricity contract, the size for each contract is 40 megawatt hours (MWh) multiplied by the number of peak days in the contract month. The selection of 40 MWh as a constant is arbitrary and is selected to meet the needs of a particular marketplace.

In the specific example, each peak day is specified to have sixteen (16) peak hours. However, it is contemplated that the contracts could be defined such that the number of peak hours varied on a day-to-day basis as well. When all peak days have 16 peak hours, the hourly delivery rate for a contract is 40 MWh 16 or 2.5 MW per hour. The specific size of a given monthly contract is then determined by multiplying the delivery rate (2.5 MW) by the peak hours per day (16) and the peak days in the contract period. The designation of peak days is made by the electricity industry (e.g., the North American Electricity Counsel) which coincide generally with business days and exchange trading days.

In a specific implementation, the present invention provides a financially settled monthly futures contract for on-peak electricity transactions based on the daily floating price for each peak day of the month at the Pennsylvania-Maryland-New Jersey (PJM) western hub. The PJM western hub consists of 111 busses, primarily on the Pennsylvania Electric Co. and the Potomac Electric Co. utility transmission systems. The daily floating prices are the arithmetic average of PJM western hub real-time “locational marginal pricing” for the 16 peak hours of each peak day, provided by the PJM Interconnection, LLC. Peak hours are from 7 AM to 11 PM prevailing local time. Locational marginal pricing is the marginal cost of supplying the next increment of power demand at a specific location on the network, taking into account the marginal cost of generation and the physical aspects of the transmission system. Peak days are Monday through Friday, excluding North American Electric Reliability Council holidays. An exemplary set of rules for settlement/delivery procedures, trading, price determination and the like are published by NYMEX as exchange rules 502.01 through 502.20, which are incorporated herein by reference.

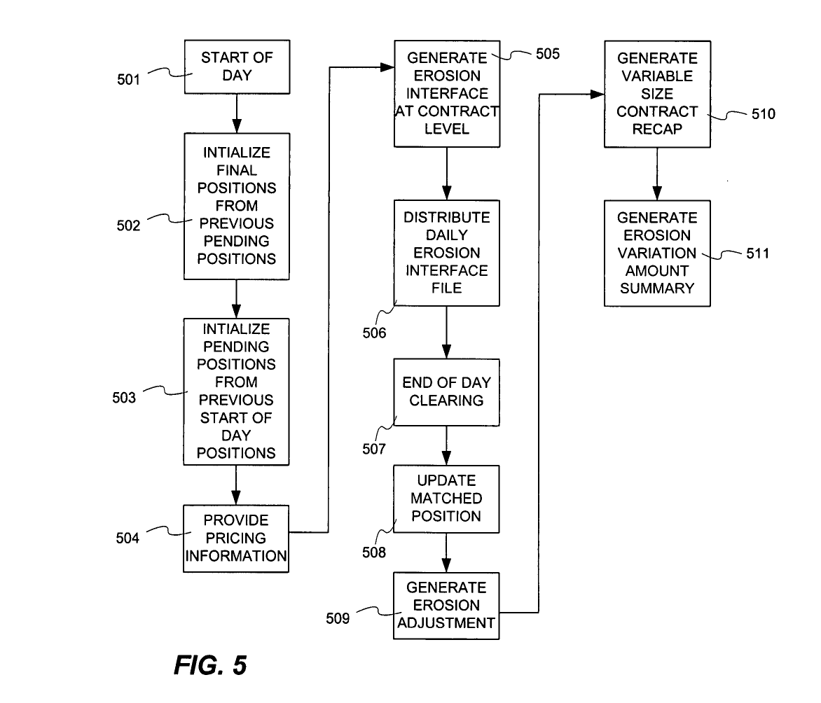

FIG. 4 illustrates how an eroding contract changes over time. An eroding contract is intentionally similar in many ways to a conventional (i.e., non-eroding) futures contract, making the product more saleable and easier to understand. Each monthly contract specifies a settlement/delivery month, also called the “contract month” which is the calendar month in which the contract will be finally settled (e.g., by financial settlement or physical delivery). Weekly contracts specify a settlement/delivery week rather than month. The contract month or contract week may be the current month/week, or may be any time in the future for which the exchange 101 has defined a contract.

Although the contract amount varies from month to month, until the contract month, the quantity of any particular futures contract is fixed and so the product resembles a substantially conventional futures contract. Unlike conventional futures contracts, settlement of an eroding futures contract occurs throughout the contract month rather than on a single date and time. In other words, throughout the contract month or week each peak day that occurs corresponds to final settlement of 40 MWh of the contract. At the end of the day, 40 MWh will be settled out of the contract and the remaining contract size will be reduced by 40 MWh.

For example, consider a contract for a month having 21 peak days such as March 2003. The contract size is 40 MWh×21 or 840 MWh. In FIG. 4, the contract size remains at 840 MWh in January and February, which for ease of illustration are only shown at a weekly level of granularity. In March, the contract month, at the end of the first peak day traders will exchange funds to close only a 40 megawatt (MWh) portion of the 840 MWh contract. The remaining 800 MWh contract remains open. The size of the contract gradually erodes throughout the contract month with each passing peak day. At the closing of the last peak day in March, 2003, the contract is entirely closed.

Alternatively, an eroding contract may be constructed as a plurality of component contracts where each component can be settled independently. For example, an 840 MWh may be constructed from 21 component contracts where the size of each component contract is 40 MWh. The components are initially traded as a group or strip of 21 contracts. Each final settlement results in one or more contracts being finally settled by exchanging funds only for the component contract (or component contracts) that are being finally settled. The quantity of the contract (i.e., the number of unsettled component contracts that remains) gradually erodes throughout the contract month with each passing settlement event. At the closing of the last peak day in March, 2003, the contract is entirely closed because all of the component contracts are closed. At any time the remaining open component contracts may be traded, preferably as a unit, although there may be circumstances in which it is desirable to allow a trader to buy/sell a subset of the component contracts.

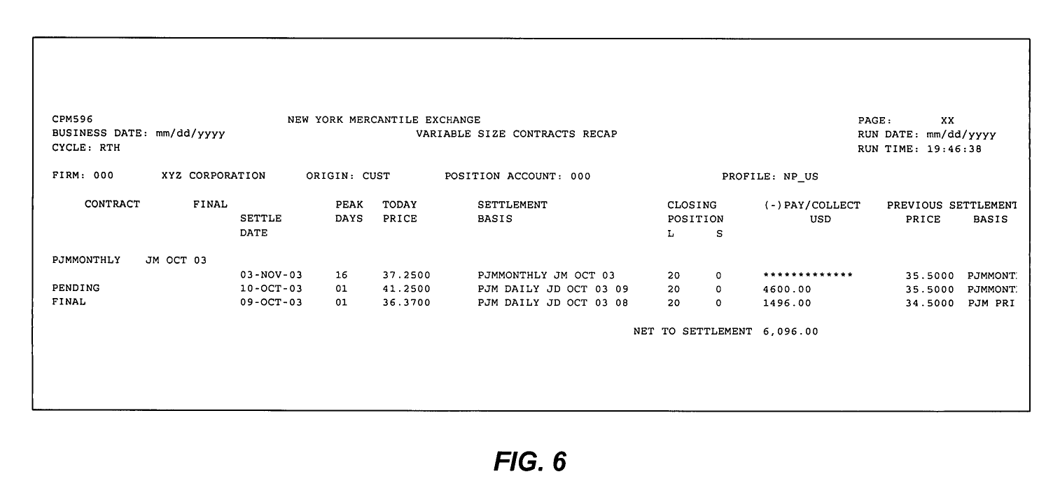

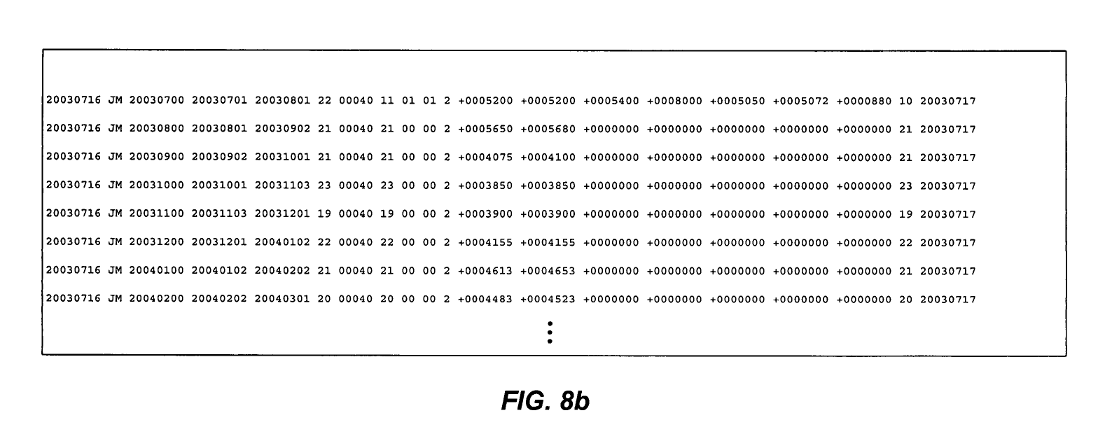

FIG. 5 illustrates an overview of an exemplary daily workflow as it pertains to the erosion/delivery process in accordance with the present invention. At 501 start of day processing generates an “EROSION DAILY” database table entry (shown in Fig. FIG. 8b) for the new business date. The EROSION DAILY database table entry contains data about one or more eroding contracts including information indicating how much of the contract position remains open and how much of the contract position has been settled and/or cleared. This information is useful during the contract month or other time period in which final settlement events are defined for the product.

In 502 and 503 the final and pending positions for the account are initialized. Essentially, a position that was pending on the previous trading day becomes final and positions that scheduled for final settlement move from open to pending. In operation 504 pricing information for the pending and finally settled portions of an eroding contract is provided from an external settlement system, including the final daily price for the underlying commodity from yesterday's daily contract.

In operation 505, an “EROSION INTERFACE” database table entry is generated for each contract for the new business date. The database entry includes, for example, contract peak days, peak days today, peak days next business day, erosion start and end dates, previous settlement price, pending and final settlement prices, and the like. This information is used to generate the “EROSION DAILY” interface file in operation 506, illustrated in report form in FIG. 8a and FIG. 8b, that is provided to Clearing Member and Service Bureaus. Also, this information may be used by end of day Clearing process to calculate daily peak value adjustments.

In operation 507, end of day clearing processing utilizes the “EROSION DAILY” and “EROSION INTERFACE” database tables (shown in FIG. 8a and FIG. 8b) populated previously to calculate the contract level daily peak value variation adjustments in 508 to update appropriate Clearing Member MATCHED POSITION variation amounts. In 509 the system generates EROSION ADJUSTMENT table entries for any “as of” trades (e.g., a trade that was executed on a prior day, but is being cleared at a later time and so the computations are back) and uses them for determining any prior day “pending” and/or “final” variation adjustments.

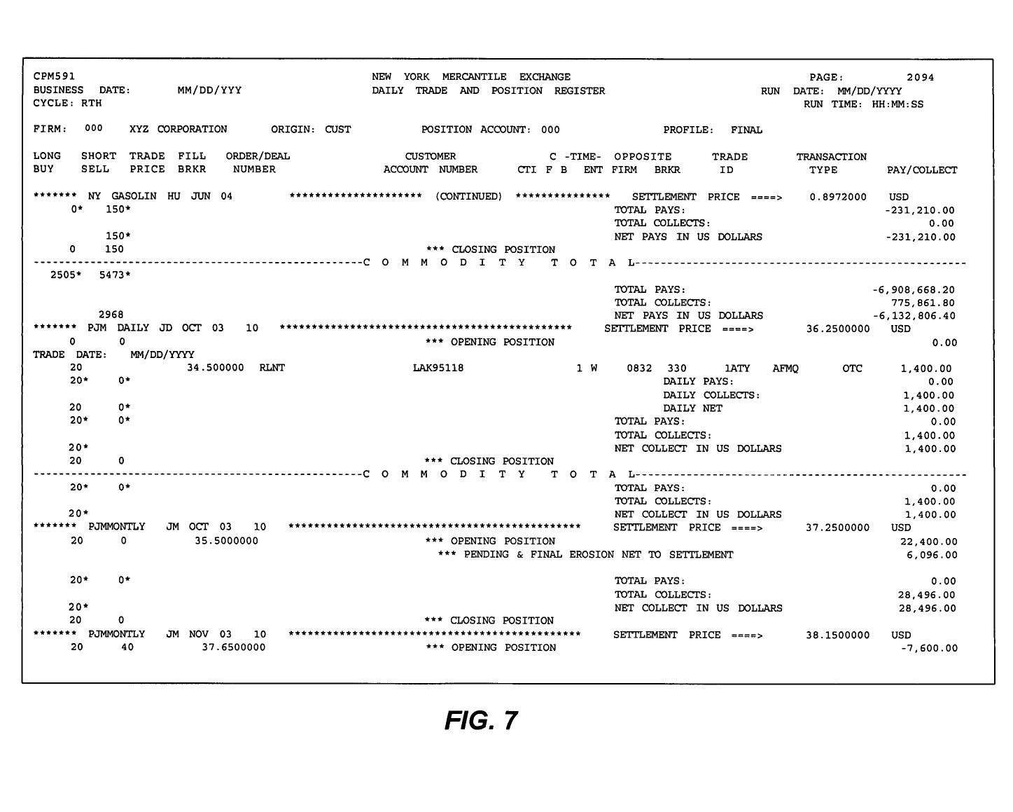

In operation 510, the daily “Variable Size Contract Recap” record is generated for each by Clearing Member. This file, an example of which is shown in FIG. 6, provides detail supporting the erosion process variation calculations. The specific example of FIG. 6 illustrates an eroding contract having a plurality of final settlement events occurring in the contract month (e.g., October 2003 in the specific example). This report identifies a particular clearing member and account and provides a summary of the activity on that account. An “open positions” value (16 in the example of FIG. 6) represents the remaining, unsettled and tradeable portion of an eroding contract. The “pending positions” value (1 in the example of FIG. 6) indicates a portion of the eroding contract that is settled but not yet final and so is not tradeable. The “final positions” value (indicated by 1 in FIG. 6) indicates a portion of the eroding contract that is finally settled. Initially the eroding contract comprises entirely open positions, and after all positions have been finally settled and terminated the eroding contract is closed out. The values of the open, pending and final positions change upon occurrence of each settlement event. Generation of the “EROSION DAILY” database involves initializing Clearing Member “final” positions from previous business date's “pending” positions in operation 502. Additionally, in 503 the clearing member “pending” positions are initialized from the Clearing Member's “start of day” positions table.

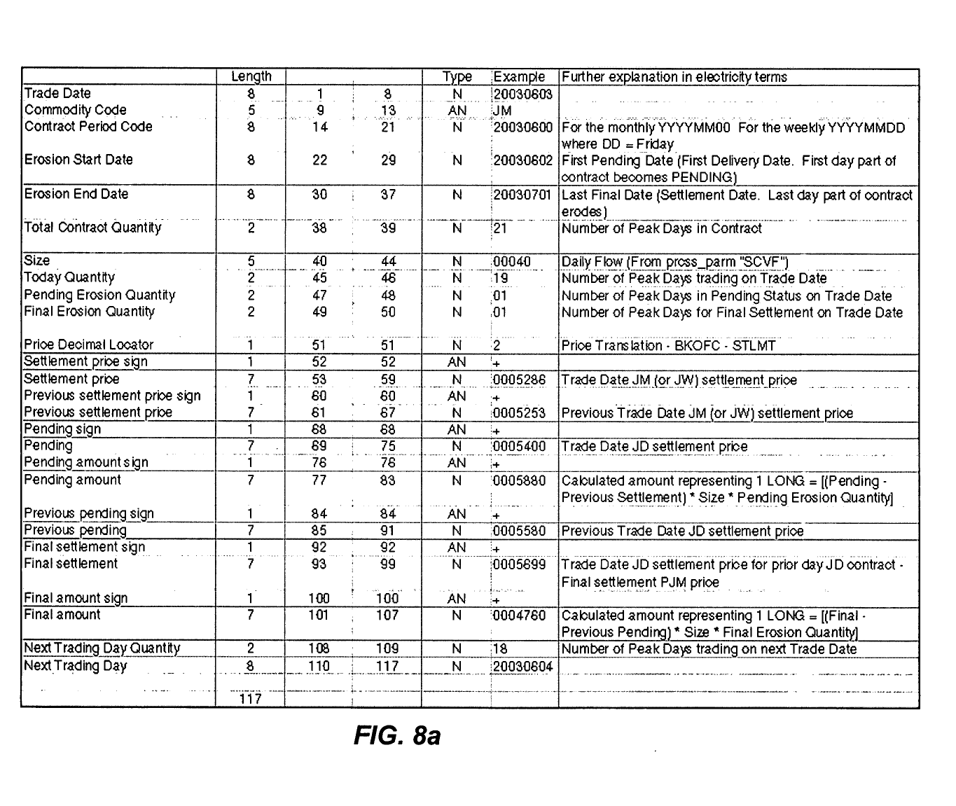

In operation 511 an erosion variation amount summary entry on a “Daily Trade and Position Register” record, shown in FIG. 7. This report summarizes the daily activity on a commodity-by-commodity basis to indicate changes in positions and value.

The various reports and information files described above may be generated according to any convenient schedule that meets the needs of the participants, but are typically generated on a daily basis during the contract month. This information can be used, for example, by the exchange system to modify margin records for a particular contract. Margin is an amount of money or collateral deposited by a trader/broker with a clearing member, or by a clearing member with the clearinghouse, for the purpose of insuring the clearing member or clearinghouse against adverse price movement on open futures contracts. Initial margin is the minimum deposit per contract required when a futures position is opened. Final settlement events result in eliminating the initial margin requirement. In the case of an eroding futures contract in accordance with the present invention, the initial margin value changes upon each settlement event to reduce or erode the initial margin for a contract in proportion to the reduction in the value of the open position for that contract.

FIG. 8a shows an exemplary erosion interface file that explains the various information that is included in a daily erosion file shown in FIG. 8b. The daily erosion file is distributed to market participants and includes information about the amounts settled in the contract month and the size of the remaining contract balance. The information is distributed in fixed-length data record (117 bits in the specific example) as shown in FIG. 8b in the particular example, although other formats that can be readily exchanged with and interpreted by the recipient are suitable substitutes. The erosion interface file of FIG. 8a specifically describes the various information that is communicated by the daily erosion file.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A method for processing a futures contract comprising:
defining an eroding futures contract having a defined size and a plurality of defined final settlement events, wherein the contract specifies a period of time over which the plurality of defined final settlement events are scheduled to occur;
executing trades between buyers and sellers of the eroding futures contract; and
upon occurrence of one of the final settlement events, finally settling part of the futures contract.

2. The method of claim 1 further comprising executing trades involving a remaining balance of the eroding futures contract which has not finally settled.

3. The method of claim 1 further comprising clearing a finally settled portion of the eroding futures contract after a defined final settlement event.

4. The method of claim 1 further comprising generating reports reflecting activity related to the trading, settlement and final settlement of the eroding futures contract.

5. The method of claim 1 wherein the defined period corresponds to a specific week.

6. The method of claim 1 wherein the defined period corresponds to a specific month.

7. The method of claim 1 wherein finally settling comprises reducing an open position value of the contract by an amount equal to a quantity of the contract that was finally settled.

8. The method of claim 1 wherein the eroding futures contract comprises a plurality of component contracts and finally settling comprises reducing an open position value of the contract by an amount equal to a quantity of contracts that were finally settled.

9. The method of claim 1 wherein each final settlement event occurs at a contract-specified settlement time and a final settlement occurs at each settlement time.

10. The method of claim 1 wherein the eroding futures contract is a fixed quantity futures contract.

11. The method of claim 1 wherein the eroding futures contract is a variable quantity futures contract.

12. A method for mitigating risk related to price volatility of a commodity comprising:
establishing a futures position involving a futures contract wherein the futures contract specifies a starting size, a settlement period, and a specified delivery location, wherein the defined settlement period covers a range of time; and
during the defined settlement period, finally settling a portion of the variable quantity futures contract.

13. The method of claim 12 further comprising clearing the finally settled portion of the futures contracts.

14. The method of claim 12 further comprising trading an unsettled balance of the finally settled portion of the futures contract.

15. The method of claim 12 wherein the defined period comprises a specific week.

16. The method of claim 12 wherein the defined period comprises a specific month.

17. The method of claim 12 wherein the act of finally settling comprises cash settlement.

18. The method of claim 12 wherein the act of finally settling comprises physical delivery.

19. An eroding futures contract comprising:
an agreement specifying a starting open position size, a term, and a plurality of contract increments;
a plurality of final settlement events defined to occur during the contract term, wherein each contract increment is associated with at least one final settlement event.

20. The eroding futures contract of claim 19 wherein occurrence of each final settlement event reduces the open position size.

21. The eroding futures contract of claim 19 wherein each contract increment is able to be finally settled and cleared independent of any other contract increment.

22. The eroding futures contract of claim 19 wherein the starting open position size is consistent from month-to-month.

23. The eroding futures contract of claim 19 wherein the starting open position size is variable from month-to-month.

24. The eroding futures contract of claim 19 wherein the contract specifies an initial margin and the initial margin is reduced upon occurrence of each final settlement event.

25. The eroding futures contract of claim 19 wherein the futures contract is tradeable after a final settlement event.
